(19) United States
(12) Patent Application Publication
(10) Pub. No.: US 2012/0115992 A1
(43) Pub. Date: May 10, 2012

(54) ADHESIVE SYSTEM AND METHOD OF PRODUCTING A WOOD BASED PRODUCT

(75) Inventors: Farideh Khabbaz, Nacka (SE); Joanna Fare, Huddinge (SE)

(73) Assignee: Akzo Nobel Coatings International B.V., Arnhem (NL)

(21) Appl. No.: 13/383,945

(22) PCT Filed: Jul. 16, 2010
(86) PCT No.: PCT/EP2010/060272

§ 371 Date: Jan. 13, 2012

Related U.S. Application Data
(60) Provisional application No. 61/226,873, filed on Jul. 20, 2009.

(30) Foreign Application Priority Data
Jul. 20, 2009 (EP) 09165858.3

(51) Int. Cl. C08L 97/02; B32B 37/12; C09J 163/00

(52) U.S. Cl. 523/447; 523/449; 156/331.6

(57) ABSTRACT

The invention relates to an adhesive system comprising a protein; a polymer comprising at least one carboxylic group or at least one carboxylic anhydride group, or a combination thereof, with the proviso that said polymer does not contain 5 to 90 wt-% of vinyl pivalate units in combination with 0.2 to 15 wt-% of primary hydroxyl group-containing vinyl compound units, and a polyamine-epihalohydrin. The invention further relates to the use of the adhesive system, an adhesive composition, a method of producing a wood based product and a wood based product.

The present invention relates to an adhesive system and a method of producing a wood based product.

### BACKGROUND

Formaldehyde based resins such as phenol-formaldehyde resin, melamine-formaldehyde resin and urea-formaldehyde resin are widely used as binders in the production of wood based products. Examples of such wood based products are composite products comprising layers glued together such as plywood, laminated flooring products and veneered products used in, e.g., furniture. Further examples of such wood based products are composite products such as particle-, chip- and fibreboards wherein wood chips and/or fibres, together with a binder, are pressed to form a board.

Upon curing a formaldehyde based resin, formaldehyde may be released both during the manufacture of the wood based product and also later during use of the product. Formaldehyde emission to indoor air is a major concern since many years for health reasons.

There is an increasing demand for formaldehyde-free wood adhesives which have sufficient water resistance and heat resistance making them suitable as alternatives to prior art adhesives containing formaldehyde based resins.

As an alternative to adhesive compositions comprising formaldehyde based resins adhesives based on polymer latices of e.g. polyvinyl acetate are available.

WO 2008/024444 discloses adhesive compositions containing polyamidoamine epihalohydrin resins of low molecular weight and a soy protein or lignin.

EP0587114 relates to an emulsion composition comprising an aqueous emulsion (A) obtained by emulsion polymerization of 100 parts by weight of an ethylenically unsaturated monomer in the presence of 1 to 15 parts by weight of a carboxyl group-modified polyvinyl alcohol as dispersant and a polyamide resin (B) such as polyamide epichlorohydrin.

US2004089418 relates to a method for making lignocellulosic composites by adhering lignocellulosic substrates together. A first variant of the method involves using an adhesive composition comprising a reaction product of (i) first ingredient selected from a soy protein or lignin and (ii) at least one substantially formaldehyde-free curing agent that includes at least one amine, amide, imine, imide, or nitrogen-containing heterocyclic functional group that can react with at least one functional group of the soy protein. A second variant of the method involves using an adhesive composition that comprises a reaction product of (i) a protein or lignin, (ii) a first compound that includes at least one amine, amide, imine, imide or nitrogen-containing heterocyclic functional group that can react with at least one functional group of the protein and (iii) a curing agent.

EP 2000485 relates to the use of (meth)acrylic acid amide(s) as comonomer(s) (b) for providing a formaldehyde-free aqueous polymer dispersion obtained by emulsion copolymerization of at least (a) vinyl ester monomer(s) and (b) comonomer(s) comprising said acrylic and/or methacrylic amide(s) derivatives in the presence of at least (c) fully hydrolyzed polyvinyl alcohol (PVOH), having an average degree of hydrolysis above 95.00 mol %, wherein the polymerization does not comprise comonomers derived from N-alkylol(meth)acrylic acid amides, and wherein the heat resistance, measured as WATT 91 value according to DIN EN 14257, is larger than the heat resistance obtained without using acrylic and/or methacrylic amide(s) derivatives (b).

JP 10-306266 relates to an adhesive composition obtained by incorporating (A) 100 parts by weight, on a resin basis, of a vinyl acetate resin-based emulsion prepared by emulsion polymerization between 100 parts by weight of vinyl acetate and 0.1-5 parts by weight of a carboxyl-containing monomer using polyvinyl alcohol as protective colloid with (B) 5-100 parts by weight, on a resin basis, of an ethylene-vinyl acetate copolymer resin-based emulsion containing ≧25 weight-% of ethylene, (C) 1-20 parts by weight, on a resin basis, of an urethane resin-based emulsion, and (D) 0.5-10 parts by weight of an aminoethylated vinyl interpolymer of the formula —C—C(CH₃)—CO—O—[—C(R₁)—C(R₂)—N—]ₙ—H where R1 is H or methyl and R2 is a hydrocarbon group, or a polyimide-epichlorohydrin-based resin.

JP5009448 relates to an adhesive prepared by adding a crosslinking agent to a base consisting mainly of a copolymer emulsion comprising 5-80 wt-% vinyl acetate units and 95-20 wt-% acrylic ester units and/or methacrylic ester units and containing polyvinyl alcohol having primary hydroxyl, primary amino or secondary amino or a copolymer emulsion comprising vinyl pivalate units, primary hydroxy-containing vinyl compound units and ethylenically unsaturated monomer units and having a glass transition temperature of −10° C. or above.

According to the Physical & Theoretical Chemistry Laboratory of Oxford University (http://msds.chem.ox.ac.uk/VI/vinyl_pivalate.html 13 Jul. 2009) vinyl pivalate is a highly flammable, harmful (by inhalation, skin contact, or if swallowed), and irritating (to the eyes, respiratory system, and to the skin) substance that may cause cancer or heritable genetic damage.

For wood adhesives the cohesion strength of the dry bond, in particular under ambient temperature, is of paramount importance. In addition, there are further demands for high quality wood adhesives, among which the water resistance play a significant role. The D1-D4 scale of standard SS-EN 204:2001 is commonly used for classification of water resistance.

It would is an object of the invention to provide an adhesive system not being based on formaldehyde releasing components, but still having high water resistance and heat resistance, in particular when used as a wood adhesive.

It is another object of the present invention to provide an adhesive system that does not involve extensive use of carcinogenic or otherwise harmful or irritating substances.

These and other objects will become apparent from the present specification and examples.

### THE INVENTION

One aspect of the invention relates to an adhesive system comprising
a protein;
a polymer comprising at least one carboxylic group or at least one carboxylic anhydride group, or a combination thereof,
   with the proviso that said polymer does not contain 5 to 90 wt-% of vinyl pivalate units in combination with 0.2 to 15 wt-% of primary hydroxyl group-containing vinyl compound units, and
a polyamine-epihalohydrin.

Said at least one carboxylic group or at least one carboxylic anhydride group may be introduced into or onto the polymer by way of carboxylation of the polymer; in the alternative, or—if more than one such group—complement, the group(s) may originate from monomer(s) making up the polymer; in the alternative, or—if more than one such group—complement, the group(s) may originate from a protective colloid used during the polymerisation, such as for instance carboxylated polyvinyl alcohol.

The polymer preferably comprise up to about 15 mole-% or from about 0.05 to about 10 mole-% of carboxylic groups based on the combined numbers of moles of monomer comprised in the polymer, or up to about 7.5 mole-% or from about 0.025 to about 5 mole-% of carboxylic anhydride groups based on the combined numbers of moles of monomer comprised in the polymer.

The carboxylic or carboxylic anhydride groups may, for instance, originate from straight or branched C₃₋₁₂ monocarboxylic acid monomers; straight or branched C₄₋₁₂ dicarboxylic acid monomers; or straight, branched, or cyclic C₄₋₁₂ carboxylic anhydride monomers, wherein the carbon chain of said monomers contains at least one terminal, pendant, or internal ethylenic unsaturation. The carboxylic or carboxylic anhydride groups may e.g. originate from ethylenically unsaturated carboxylic or carboxylic anhydride group containing monomers used at the preparation of the polymer. Such monomers may include one or more of acrylic acid, methacrylic acid, crotonic acid, isocrotonic acid, itaconic acid, itaconic anhydride, maleic acid, maleic anhydride, and fumaric acid, of which acrylic acid, methacrylic acid and mixtures thereof are particularly preferred.

By the term “adhesive system” as used herein is meant a combination of components which function as, and is intended to be used as, an adhesive when combined.

In the term “adhesive” is herein also included the term “binder”.

As used herein, the term “protein” also encompasses protein hydrolysates, that is mixtures of amino acids prepared by splitting a protein with acid, alkali, or enzyme.

As used herein, the term “polymer” refers to the product of a polymerization reaction, and is inclusive of homopolymers, copolymers, terpolymers, etc.

As used herein, unless specified otherwise, the term “copolymer(s)” refers to polymers formed by the polymerization of at least two different monomers.

As used herein, unless specified otherwise, the term “homopolymer(s)” refers to polymers formed by the polymerization of at least two similar monomers.

As used herein, when a polymer is referred to as “comprising a monomer,” the monomer is present in the polymer in the polymerized form of the monomer or in the derivative form of the monomer.

The term “ethylenically unsaturated monomer” is used herein to refer to a monomer containing at least one carbon-carbon double bond.

The term “ethylenically unsaturated carboxylic acid monomer” is used herein to refer to a monomer containing at least one carbon-carbon double bond and at least one carboxylic acid group.

The term “ethylenically unsaturated carboxylic anhydride monomer” is used herein to refer to a monomer containing at least one carbon-carbon double bond and at least one carboxylic anhydride group.

The term “(meth)acrylate” refers to both the acrylate and methacrylate equally and the term (meth)acrylic acid refers to acrylic or methacrylic acid equally.

The term “vinyl polymer” as used herein means a polymer prepared from monomers comprising at least one of the following groups:

vinylidene CH₂═C<,
vinyl CH₂═CH—,
vinylene —CH═CH—,
whether homopolymerizable or not. Examples of known vinyl polymers and methods of preparing the same are set forth in, for instance, “Polymer Processes,” Schildknecht, Interscience, N.Y. (1956), pp. 111-174.

As used herein, the term “carboxylated starch” refers to starch having one or more carboxyl groups (i.e., carboxylic acid groups or carboxylate salt groups).

The term “carboxymethyl cellulose” as used herein refers to carboxymethyl cellulose (CMC) or its additionally substituted derivatives such as carboxymethyl methylcellulose (CMMC), carboxymethyl hydroxyethylcellulsoe (CMHEC), and carboxymethyl hydroxypropylcellulose (CMHPC).

The term “polyamine-epihalohydrin” as used herein refers to polyamine-epihalohydrin resins, including those that have been prepared with epihalohydrin, e.g. epichlorohydrin, as a reactant, either during the polymerisation or in the modification of an existing polymer. The polyamine may be a polyaminoamide. Such resins are widely used as wet strength agents in paper making and are commercially available, e.g. from Akzo Nobel under the trademarks Eka WS 320, Eka WS 320 RC, Eka WS 325, Eka WS XO, and Eka WS X14. Further, preparation thereof is disclosed in the literature, e.g. in any one of U.S. Pat. No. 4,450,045, U.S. Pat. No. 3,311,594, U.S. Pat. No. 4,336,835, U.S. Pat. No. 3,891,589, U.S. Pat. No. 2,926,154, U.S. Pat. No. 4,857,586, U.S. Pat. No. 4,975,499, U.S. Pat. No. 5,017,642, U.S. Pat. No. 5,019,606, U.S. Pat. No. 5,093,470 and U.S. Pat. No. 5,516,885.

In the art, polyaminoamide may also be referred to as polyamidoamine, polyaminopolyamide, polyamidopolyamine, polyamidepolyamine, polyamide, basic polyamide, cationic polyamide, aminopolyamide, amidopolyamine or polyaminamide.

The polyaminoamide epihalohydrin resin may be in an aqueous solution, that further may comprise a water-miscible solvent such as methanol, ethanol or dimethyl formamide. The molecular weight can vary within wide ranges and Mw may, for example, be from about 10,000 to about 1,000,000 or higher, such as from about 50,000 to about 1,000,000.

Epihalohydrins that can be used include epibromohydrin and epichlorohydrin, in particular epichlorohydrin. The polymers may be produced using, for instance, from about 0.5 to about 2 moles of epihalohydrin per mole of basic nitrogen in the polyaminoamide.

The polyaminoamide may be a reaction product of a polycarboxylic acid or a derivative thereof, such as a dicarboxylic acid or a derivative thereof, and a polyamine. Derivatives of carboxylic acids include e.g. anhydrides, esters and half esters. Exemplary polycarboxylic acids include saturated or unsaturated aliphatic or aromatic dicarboxylic acids. For the purpose of the invention, the term “carboxylic acid” is meant to include carboxylic derivatives, such as anhydrides, esters or half esters. The polycarboxylic acids may contain up to 10 carbon atoms, and may be chosen among oxalic acid, malonic acid, succinic acid, glutaric acid, adipic acid, azelaic acid, sebacic acid and derivatives and mixtures thereof.

The polyamine may, for instance, be chosen among polyalkylene polyamines, or mixtures thereof, satisfying the following formula:

H₂N—(CR¹H)ₐ—(CR²H)_{b}—N(R³)—(CR⁴H)_{c}—(CR⁵H)_{d}—NH₂ (II)

in which R¹-R⁵ represent hydrogen or lower alkyl, preferably up to C₃ and a-d represent integers from 0-4. Exemplary polyalkylene polyamines include diethylene triamine, triethylene tetra amine, tetraethylene penta amine, dipropylene triamine, and mixtures thereof. The polyamines of formula I may be combined with other polyamines or mixtures of other amines. The amines may, for instance, satisfy the following formulae III-VIII:

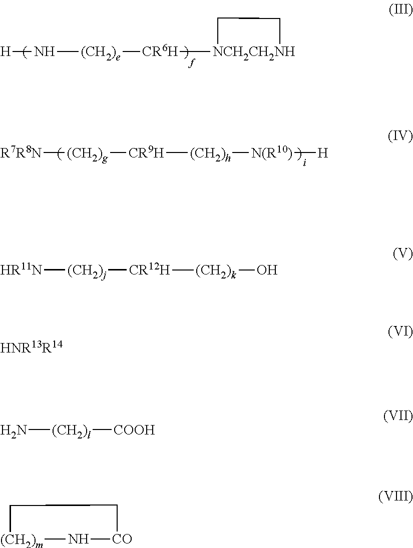

in which R⁶-R¹⁴ represent hydrogen or lower alkyl, preferably up to C₃, e-l represent integers from 0 to 4, and m represents an integer from 1 to 5.

The polyamines may be used in combination with monoamines, i.e., compounds containing only one amine group (being a primary, secondary or tertiary amine group).

The polycarboxylic acid and the polyamine may, for example, be applied in a mole ratio of from 0.5:1 to 1.5:1 or from 0.7:1 to 1.4:1.

Preparation of polyaminoamides can be performed by any method known in the art, such as described in e.g. U.S. Pat. No. 5,902,862.

The polyamine may be reacted with from about 0.1 to about 3 moles of epihalohydrin per mole of secondary amine group in the starting polyamine, in particular with from 0.5 to 1.5 moles and specifically from 0.8 to 1.2 moles per mole of secondary amine groups. A molar excess of epihalohydrin with respect to the secondary amine groups of the polyamine may be used in order to improve the stability of the final resin product.

The polymer may, for instance, be chosen among polymers obtainable from of at least one ethylenically unsaturated monomer, carboxylated starch, and carboxymethyl cellulose.

The polymer may, for instance, be a vinyl polymer.

The polymer may, for instance, be chosen among copolymers obtainable from ethylenically unsaturated monomers comprising vinyl monomers or acrylic monomers, or combinations thereof. Said ethylenically unsaturated monomer may, for instance, comprise an ethylenically unsaturated carboxylic acid monomer or an ethylenically unsaturated carboxylic anhydride monomer, or a combination thereof.

The polymer may, for instance, be a homopolymer of acrylic acid monomers or methacrylic acid monomers.

The polymer may, for instance, be polyvinyl alcohol or styrene-butadiene rubber, or a combination thereof.

Said polymer may, for instance, be chosen among polyethylene-acrylic acid (PEAA), polyvinyl acetate (PVAc), ethylene methyl acrylate copolymer (EMA), polyethyl methacrylate (PEMA), ethylene vinyl acetate copolymer (EVA), and combinations thereof.

The polymer may, for instance, be a copolymer of a vinyl monomer and at least one monomer chosen among straight and branched C₃₋₁₂ monocarboxylic acid monomers; straight and branched C₄₋₁₂ dicarboxylic acid monomers; and straight, branched, and cyclic C₄₋₁₂ carboxylic anhydride monomers, wherein the carbon chain of said monomers contains at least one terminal, pendant, or internal ethylenic unsaturation.

The polymer may, for instance, be a copolymer of a vinyl monomer and at least one monomer chosen among acrylic acid, methacrylic acid, crotonic acid, isocrotonic acid, itaconic acid, maleic acid, fumaric acid, itaconic anhydride and maleic anhydride, particularly acrylic acid, methacrylic acid or a combination thereof.

In an embodiment the polymer is obtainable from monomers comprising vinyl ester monomers and (meth)acrylate monomers. In one aspect of said embodiment the monomers for the polymer comprise at least about 45 mole-% or from about 55 to about 99 mole-% of vinyl ester monomers. Said vinyl ester monomer may for instance be a vinyl acetate monomer. It is preferred that vinyl pivalate or other harmful monomers are not included. In one aspect of said embodiment the monomers for the polymer comprise up to about 40 mole-% or from about 1 to about 35 mole-% of (meth)acrylate monomers, for example from 5 to 25 mol-% or from 10 to 20 mol-%. Said (meth)acrylate monomers may, for instance, be chosen among alkyl(meth)acrylates, hydroxyalkyl(meth)acrylates, alkyl di(meth)acrylates, epoxy(meth)acrylates, and combinations thereof; more specifically said (meth)acrylate monomers may, for instance, be chosen among ethyl acrylate, methyl acrylate, n-butyl acrylate, i-butyl acrylate, t-butyl acrylate, methyl methacrylate, 2-ethylhexyl acrylate, cyclohexyl acrylate, cyclopentanyl methacrylate, 2-hydroxyethyl (meth)acrylate, 2-hydroxypropyl acrylate, tetrahydrofurfuryl acrylate, and combinations thereof. Even more specifically said (meth)acrylate monomers may, for instance, be chosen among n-butyl acrylate or methyl methacrylate, or a combination thereof, particularly methyl methacrylate. In one aspect of said embodiment the polymer comprises up to about 15 mole-% or from about 0.05 to about 10 mole-% of carboxylic groups based on the combined numbers of moles of monomer comprised in the polymer, or up to about 7.5 mole-% or from about 0.025 to about 5 mole-% of carboxylic anhydride groups based on the combined numbers of moles of monomer comprised in the polymer. In one aspect of said embodiment the carboxylic or carboxylic anhydride groups originate from ethylenically unsaturated carboxylic or carboxylic anhydride group containing monomers used together with the vinyl ester monomers and the (meth)acrylate monomers at the preparation of the polymer. Such monomers may include one or more of acrylic acid, methacrylic acid, crotonic acid, isocrotonic acid, itaconic acid, itaconic anhydride, maleic acid, maleic anhydride, and fumaric acid, of which acrylic acid, methacrylic acid and mixtures thereof are particularly preferred. In one aspect of said embodiment the carboxylic or carboxylic anhydride groups originate from a carboxylic or carboxylic anhydride containing protective colloid used during the polymerisation, for example carboxylated polyvinyl alcohol.

In an embodiment of the invention the polymer is obtainable from monomers comprising vinyl ester monomers, (meth)acrylate monomers and carboxylic acid or carboxylic anhydride group containing monomers, the polymer being either free from any other kind of monomers or the content of any such other kinds of monomers being less than 1 mole %.

In an embodiment, additional monomers for internal crosslinking may be used, for examples in amounts up to 1 mole-% or up 0.5 mole-%. Examples of such monomers include ethylene glycol di(meth)acrylate, di(ethylene glycol) dimethacrylate, butylene glycol dimethacrylate, 1,4-butanediol diacrylate, pentaerythritol triacrylate, trimethylolpropane tri(meth)acrylate, trimethylolpropane diallylether, allyl (meth)acrylate, diallyl maleate, triallyl(iso)cyanurate, and combinations thereof.

The protein may, for instance, be chosen among native proteins and modified proteins originating from milk, soy, potato, oatley, Zea mays (corn or maize), Triticum aestivum (common wheat), Triticum durum (durum wheat), rice, rapes and peas.

The protein may be present in the form of a protein concentrate, meal, a protein isolate, or a combination thereof.

The protein may, for instance, originate from soy and may, for instance, be chosen among soy protein concentrate, soy meal, and soy protein isolate.

The protein may, for instance, originate from Triticum aestivum or Triticum durum) and may, for instance, be chosen among meal of Triticum aestivum and meal of Triticum durum.

The protein may, for instance, be gluten or zein, or a combination thereof.

The protein and the polymer may, for instance, be comprised in a resin component, and said polyamine-epihalohydrin may, for instance, be comprised in a hardener component, said components being separate from each other. The resin component may also comprise part of the polyamine-epihalohydrin.

The protein and the polymer may, for instance, be comprised in a resin component, and said polyamidoamine-epichlorohydrin may, for instance, be comprised in a 1^{st} component, and said protein may, for instance, be comprised in a 2^{nd} component, said components being separate from each other.

The polymer and the polyamidoamine-epichlorohydrin may also, for instance, be comprised together in a mixture.

The adhesive system may further comprise additives chosen among, for instance, preservatives, antifoaming agents, viscosity adjusting agents; fillers such as kaolin, calcium carbonate, and other additives known to be suitable for use in wood adhesive formulations, including combinations thereof.

An aspect of the invention relates to an adhesive composition comprising the inventive adhesive system.

Another aspect of the invention relates to the use of the adhesive system according to the invention for producing a wood based product.

A further aspect of the invention relates to a method of producing a wood based product, comprising applying the inventive adhesive system onto one or more pieces of a wood-based material, and joining the one or more pieces with one or more further pieces of a material.

Still a further aspect of the invention relates to a wood based product obtainable by this method.

By “wood-based materials” as used herein, is beside solid wood, also included wooden materials such as fibre-, chip-, and particleboard materials. The surfaces to be joined may be of the same or different type of wood based material.

The wood based material can be any type and form of wood based material such as chips, fibres, sheets, laminas, veneers, pieces etc.

In the inventive method the adhesive system may, for instance, comprise one component comprising said protein and said polymer, and another component comprising said polyamine-epihalohydrin, and the two components may, for instance, be applied onto the wood based material as separate components. In an embodiment, part of the polyamine-epihalohydrin is included in the component comprising the protein and the polymer.

In the inventive method the adhesive system may, for instance, comprise one component comprising said polymer and said polyamine-epihalohydrin, and another component comprising said protein, and the two components may, for instance, be applied onto the wood based material as separate components.

Said two components may, for instance, be applied in a sequence of time from each other, as a first component applied and as a second component applied onto the wood based material; the first component applied may, for instance, comprise said polymer and the second component applied may, for instance, comprise polyamine-epihalohydrin.

In the inventive method the protein, the polymer, and the polyamidoamine-epichlorohydrin of said adhesive system may, for instance, be comprised together in a mixture.

The inventive method may comprise mixing wood based chips with the adhesive system, and joining the chips.

As used herein the term “wood chips” includes chips, shavings, flakes, sawdust particles and any similar finely divided wood based material.

The moisture content of the chips before mixing with said copolymer may, for instance, be from 0 to about 30 weight-%; it may, for instance, be from 0 to about 10 weight-%; or from 0 to about 5 weight-%.

The moisture content of the mixture of chips and adhesive system at the beginning of the pressing may, for instance, be from about 3 to about 25 weight-%; it may, for instance, be from about 5 to about 20 weight-%, or from about 7 to about 15 weight-%.

In an embodiment of the inventive method the wood based product is a chip-, particle-, or fibre board, or an oriented strand board. The wood based chips it may, for instance, be mixed with the adhesive system to form a mixture of chips and adhesive system, which is then pressed into a board.

The pressing may, for instance, be take place at an elevated temperature. The pressing temperature depends on which wood based product intended to be manufactured but may be from about 50 to about 250° C., specifically from about 90 to about 200° C.

The pressing time and pressing temperature are linked so that lower pressing temperatures generally require longer pressing times. The wood based product to be produced does also determine suitable pressing temperatures and pressing times. The pressing time may be at least about 10 s, such as from about 10 s to about 60 minutes, for instance at least about 30 s, or from about 30 s to about 30 minutes, e.g at least about 1 minute, or from about 1 to about 15 minutes.

A further embodiment of the inventive method comprises applying the adhesive system onto a sheet-like material, and joining it with a further sheet-like material.

The term “sheet-like material” as used herein refers to materials having dimensions in either the length or width directions, or both, that are much greater than the dimension of the material in the thickness direction; exemplary of sheet-like materials are laminas, boards, veneer, and the like.

One embodiment of the invention relates to a wood based product comprising pieces of wood based material joined with the adhesive system; the wood based product may, for instance, be a laminated or veneered material; or the wood based product may, for instance, be a composite product such as a particle board, fibre board, chip board or oriented strand board.

The wood based product of the present invention may, for instance, be a laminated or veneered material, such as laminated flooring, veneered flooring, a veneered furniture material, plywood, a wall panel, a roofing panel, a laminated beam, or a composite product such as a particle board, fibre board, chip board or oriented strand board.

In one embodiment of the present invention the wood based product comprises a composite product comprising wood based chips joined together with the inventive adhesive system.

One embodiment of the invention relates to the use of the adhesive system according to the invention for producing a suberin-containing product.

The invention is further illustrated by means of the following non-limiting examples. Parts and percentages relate to parts by weight respectively percent by weight, unless otherwise stated.

### EXAMPLES

In the below examples the following chemicals were used:

| Material/chemical | Description | Supplier |
|---|---|---|
| DN60 | Carboxylated PVAc | Celanese |
| | dispersion | |
| Milli-Q water | Ultrapure laboratory | |
| | grade water (filtered | |
| | and purified by | |
| | reverse osmosis) | |
| Provabis ® 200/80 | Soy meal | Cargill Foods |
| Eka WS 325 | Polyaminoamide- | Akzo Nobel |
| | epihalohydrin | |
| | crosslinking agent | |
| Eka WS XO | Polyaminoamide- | Akzo Nobel |
| | epihalohydrin | |
| | crosslinking agent | |
| Omyalite 90 | Ground calcium | Omya |
| | carbonate filler | |
| PEAA 4983 R | Polyethylene- | Michel Prime |
| | acrylic acid | |
| Lysamine CWS | Pea protein | Roquette |
| Wheat flour | Wheat flour | Kungsörnen |
| Durum flour | Durum wheat flour | Nord Mills |
| Wheat gluten | Wheat gluten | Lantmännen |
| Reppe Vital | | Reppe AB |
| Rape meal | Rape meal | Lantmännen |
| | | Reppe AB |
| Drank meal | Residual from | Lantmännen Reppe AB |
| | ethanol factory | |

### Example 1

### Preparation of Resin Components

The resin components were mixed according to the recipes in Table 1 below for 2 hours at ambient temperature.

TABLE 1

| | | | Dry | | |
|---|---|---|---|---|---|
| Resin | | | content | Viscosity | pH- |
| component | Recipe | pH | (%)* | (cP)* | adjustment |
| I | 25 g DN60 | 6 | 36.3 | ~53500 | no |
| | 50 g Milli-Q water | | | | |
| | 22 g Provabis ® | | | | |
| | 200/80 | | | | |
| II | 25 g DN60 | 6 | 36.3 | ~53500 | ~8 ml 10% |
| | 50 g water | | | | Na₂CO₃ to |
| | 22 g Provabis ® | | | | pH 8-9 |
| | 200/80 | | | | |
| III | 60 g EKA WS 325 | 5 | 37.4 | ~23000 | no |
| (reference) | 18 g Provabis ® | | | | |
| | 200/80 | | | | |
| IV | 100 g Milli-Q water | 6-7 | 20.7 | ~13000 | no |
| (reference) | 29 g Provabis ® | | | | |
| | 200/80 | | | | |
| V | 100 g Milli-Q water | 6-7 | 20.7 | ~13000 | ~8 ml 10% |
| (reference) | 29 g Provabis ® | | | | Na₂CO₃ |
| | 200/80 | | | | to pH 8 |
| VI | 60 g DN60 | 7-8 | 69.5 | ~92000 | no |
| (reference) | 17.3 g Omyalite 90 | | | | |
| VII | 40 g DN60 | 6-7 | 34% | 12000 | no |
| | 75 g Milli-Q-warer | | | | |
| | 26 g Lysamin CWS | | | | |

*before pH-adjustment

Dry contents were measured by means of an Sartorius Thermo Control YTC 01L IR drier; pH were measured with pH strips. Viscosities were measured by means of a Brookfield viscosimeter, using spider #4.

### Preparation of Adhesive Compositions and Test Specimens

Test specimens were prepared for test according to standard SS-EN 204:2001 by gluing beechwood board assemblies with adhesive compositions as indicated in Table 2 below. The board assemblies were pressed at 110° C. for 15 minutes at a pressure of 90 bar. Adhesive amount: 180 g/m².

TABLE 2

| Test | Resin component | pH | Hardener component |
|---|---|---|---|
| A1 | I | 6 | EKA WS 325, 100:20 |
| A2 | II | 8-9 | EKA WS 325, 100:10 |
| A3 | II | 8-9 | EKA WS 325, 100:20 |
| A4 | II | 8-9 | EKA WS 325, 100:30 |
| B1 (reference) | III | 5 | no |
| C1 (reference) | IV | 6-7 | no |
| C2 (reference) | V | 8 | EKA WS 325, 100:20 |
| E1 (reference) | VI | 7-8 | EKA WS 325, 100:20 |
| F1 | VII | 6-7 | EKA WS 325, 100:20 |

Four different pre-treatments were used depending on the classification to be tested. The pre-treatments and denotations are given in Table 3 below.

TABLE 3

| Notation | Pre-treatment |
|---|---|
| D1 | 8 test sticks were prepared with each respective adhesive |
| | composition of Table 2. The sticks were conditioned in a |
| | climate room for a week before being subjected to a |
| | tensile strength test-in dry state-in an Alwetron testing |
| | machine. |
| D3 | 8 test sticks were prepared with each respective adhesive |
| | composition of Table 2. The sticks were conditioned in a |
| | climate room for a week, then submerged in water at |
| | ambient temperature for 4 days, before being subjected to |
| | a tensile strength test-in wet state-in an Alwetron testing |
| | machine. |
| D4 | 8 test sticks were prepared with each respective adhesive |
| | composition of Table 2. The sticks were conditioned in a |
| | climate room for a week, then submerged in boiling |
| | water for 6 h, followed by cooling in cold water for 1 h, |
| | before being subjected to a tensile strength test-in wet |
| | state-in an Alwetron testing machine. |
| WATT 91 | 8 test sticks were prepared with each respective adhesive |
| | composition of Table 2. The sticks were conditioned in a |
| | climate room for a week, then heated in an oven to 80° C. |
| | for 1 h, before being subjected to a tensile strength test-in |
| | hot state-in an Alwetron testing machine. |

### Tensile Strength Tests

The tensile strength test values (in MPa) obtained are set forth in Table 4 below.

TABLE 4

| Dispersion | D1 | D3 | D4 | WATT91 |
|---|---|---|---|---|
| A1 | 12.24 | 5.228 | 3.012 | 11.65 |
| A2 | 14.05 | 2.901 | 1.045 | 11.91 |
| A3 | 12.89 | 3.917 | 1.184 | 10.87 |
| A4 | 16.39 | 5.257 | 1.919 | 13.01 |
| B1 | 11.14 | 4.162 | 1.598 | 10.05 |
| C1 | 11.76 | Delaminated | Delaminated | 11.05 |
| C2 | 11.34 | 2.892 | 1.451 | 11.04 |
| E1 | 10.59 | 1.984 | Delaminated | 7.292 |
| F1 | 14.54 | 4.88 | 2.79 | 10 |

### Poplar Veneering Test

One piece of poplar veneer (15 cm×15 cm), was covered evenly with about 150 g/m² of dispersion F1 as adhesive. Another piece was put crosswise onto the first one and the two pieces were then pressed together for one minute at a temperature of 115° C. and with a pressure of 1.1 metric ton. The samples were conditioned for seven days at 23±2° C., 50±5% RH before they were evaluated. After conditioning the samples were soaked in water at room temperature for one and two weeks. The joints were then immediately examined for delamination and it was found that no delamination had occurred.

### Example 2

### Preparation of Resin Components

Resins based on PEAA (10%) were prepared according to the recipes in Table 5 below. Any pH adjustment were made by means of 5% NaOH. 1% (based on total dispersion) sodium bensoat was added to each dispersion.

TABLE 5

| Sample | Recipe |
|---|---|
| A | 20 g pea protein (Lysamine CWS) was dispersed in 150 g |
| | PEAA 4983 R (dry content 10%). 1.7 g sodium bensoate |
| | was used as preservative agent. 10 g EKA WS 325 was |
| | added to 50 g dispersion before gluing. |
| B | 19.4 g soy flour was dispersed in 150 g PEAA 4983 R |
| | (dry content 10%). 1.7 g sodium bensoate was used as |
| | preservative agent. 10 g EKA WS 325 was added to |
| | 50 g dispersion before gluing. |
| C | 50 g wheat flour was dispersed in 150 g PEAA 4983 R |
| | dry content 10%). 1.7 g sodium bensoate was used as |
| | preservative agent. 10 g EKA WS 325 was added to |
| | 50 g dispersion before gluing. |
| D | 21.2 g Wheat gluten Reppe Vital was dispersed in 150 g |
| | PEAA 4983 R dry content 10%). 1.7 g sodium bensoate |
| | was used as preservative agent. 10 g EKA WS 325 was |
| | added to 50 g dispersion before gluing. |
| E | 32.5 g rape meal was dispersed in 150 g PEAA 4983 R |
| | dry content 10%). 1.7 g sodium bensoate was used as |
| | preservative agent. 10 g EKA WS 325 was added to |
| | 50 g dispersion before gluing. |
| F | 74.0 g drank meal 150 g PEAA 4983 R dry content 10%). |
| | 2.2 g sodium bensoate was used as preservative agent. |
| | 10 g EKA WS 325 was added to 50 g dispersion before |
| | gluing. |

Two resins based on DN60 (10%) was prepared according to the recipe in Table 6 below.

TABLE 6

| Sample | Recipe |
|---|---|
| G | 100 g wheat flour was dispersed in 150 g DN-60 (dry content |
| | 10%). 2.2 g sodium bensoate was used as preservative agent. |
| | 10 g Eka WS 325 was added to 50 g dispersion before gluing. |
| H | 50 g soy flour was dispersed in 150 g DN-60 (dry content |
| | 10%). 2 g sodium bensoate was used as preservative agent. |
| | 10 g Eka WS 325 was added to 50 g dispersion before gluing. |

### Preparation of Adhesive Compositions and Test Specimens

Adhesive compositions were prepared from each resin A-H by mixing 100 parts by weight of resin with 20 parts by weight of EKA WS XO.

Test specimens were prepared by gluing beech boards (135*800*5 mm) with an adhesive anout of 180 g/m². The boards were pressed together for 10 minutes at 110° C. and 0.7 MPa.

### Tensile Strength Tests

The tensile strength test values (in MPa) obtained when tested according to SS-EN 204:2001 are set forth in Table 8 below.

TABLE 8

| Sample | D1 | D2 | D3 | WATT 91 |
|---|---|---|---|---|
| A | 13.2 | 10.34 | 3.729 | 9.923 |
| B | 11.62 | 7.125 | 3.8 | 9.254 |
| C | 11.71 | 9.033 | 0.853 | 9.284 |
| D | 11.54 | 6.694 | 2.993 | 8.728 |
| E | 8.449 | 5.659 | 2.773 | 3.182 |
| F | 10.16 | 7.945 | 3.467 | 2.782 |
| G | 11.87 | 8.265 | 0.518 | 9.273 |
| H | 13.48 | 14.32 | 4.159 | 13.08 |

1. Adhesive system comprising
a protein;
a polymer comprising at least one carboxylic group or at least one carboxylic anhydride group, or a combination thereof,
with the proviso that said polymer does not contain 5 to 90 wt-% of vinyl pivalate units in combination with 0.2 to 15 wt-% of primary hydroxyl group-containing vinyl compound units,
and
a polyamine-epihalohydrin.

2. The adhesive system according to claim 1, wherein said polymer is selected from polymers obtained from at least one ethylenically unsaturated monomer,
carboxylated starch, carboxymethyl cellulose, and combinations thereof.

3. The adhesive system according to claim 1, wherein said polymer is a vinyl polymer.

4. The adhesive system according to claim 1, wherein said polymer is selected from copolymers obtained from ethylenically unsaturated monomers comprising vinyl monomers or acrylic monomers, or combinations thereof.

5. The adhesive system according to claim 4, wherein said ethylenically unsaturated monomer comprises an ethylenically unsaturated carboxylic acid monomer or an ethylenically unsaturated carboxylic anhydride monomer, or a combination thereof.

6. The adhesive system according to claim 1, wherein said polymer is a homopolymer of acrylic acid monomers or methacrylic acid monomers.

7. The adhesive system according to claim 1, wherein said polymer is polyvinyl alcohol or styrene-butadiene rubber, or a combination thereof.

8. The adhesive system according to claim 1, wherein said polymer is a copolymer of a vinyl monomer and at least one monomer selected from
straight and branched C₃₋₁₂ monocarboxylic acid monomers;
straight and branched C₄₋₁₂ dicarboxylic acid monomers; and
straight, branched, and cyclic C₄₋₁₂ carboxylic anhydride monomers, wherein the carbon chain of said monomers contains at least one terminal, pendant, or internal ethylenic unsaturation.

9. The adhesive system according to claim 1, wherein said protein is selected from native proteins and modified proteins originating from milk, soy, potato, oatley, Zea mays (corn or maize), Triticum aestivum (common wheat), Triticum durum (durum wheat), rice, rapes and peas.

10. Adhesive composition comprising an adhesive system according to claim 1.

11. Method of producing a wood based product, comprising applying an adhesive system onto one or more pieces of a wood-based material, and joining the one or more pieces with one or more further pieces of a material, wherein the adhesive system is an adhesive system according to claim 1.

12. The method according to claim 11, comprising mixing wood based chips with the adhesive system, and joining the chips.

13. The method according to claim 11, comprising applying the adhesive system onto a sheet-like material, and joining it with a further sheet-like material.

14. Wood based product obtained by the method according claim 11.

15. (canceled)

16. The adhesive system according to claim 1, wherein the polymer comprises up to about 15 mole-% of carboxylic groups based on the combined number of moles of monomer in the polymer, or up to about 7.5 mole-% of carboxylic anhydride groups based on the combined number of moles of monomer in the polymer.

17. The adhesive system according to claim 1, wherein the polyamine-epihalohydrin has a molecular weight Mw from about 10,000 to about 1,000,000.

18. The adhesive system according to claim 1, wherein the epihalohydrin is epichlorohydrin.

19. Adhesive system comprising a protein;
a copolymer of a vinyl monomer and at least one monomer selected from acrylic acid, methacrylic acid, crotonic acid, isocrotonic acid, itaconic acid, maleic acid, fumaric acid, itaconic anhydride and maleic anhydride, said polymer comprising from about 0.05 up to about 15 mol-% of at least one carboxylic group or from about 0.025 up to about 7.5 mole-% of carboxylic anhydride groups based on the combined numbers of moles of monomer comprised in the polymer,
with the proviso that said polymer does not contain 5 to 90 wt-% of vinyl pivalate units in combination with 0.2 to 15 wt-% of primary hydroxyl group-containing vinyl compound units,
and
a polyaminoamide-epichlorohydrin.

20. The adhesive system of claim 19, wherein the co-polymer is obtained from monomers comprising at least one vinyl ester monomer, at least one (meth)acrylate monomer and at least one monomer selected from acrylic acid, methacrylic acid, crotonic acid, isocrotonic acid, itaconic acid, maleic acid, fumaric acid, itaconic anhydride and maleic anhydride.
